(19) United States
(12) Patent Application Publication
(10) Pub. No.: US 2019/0286348 A1
(43) Pub. Date: Sep. 19, 2019

(54) STORAGE DEVICE, CONTROL METHOD, AND CONTROL PROGRAM

(71) Applicant: Toshiba Memory Corporation, Tokyo (JP)

(72) Inventors: Takeshi ISHIHARA, Yokohama Kanagawa (JP); Yuichiro OYAMA, Meguro Tokyo (JP); Hiroshi NISHIMOTO, Kawasaki Kanagawa (JP); Eimi MURAKAMI, Koto Tokyo (JP)

(21) Appl. No.: 16/289,340

(22) Filed: Feb. 28, 2019

(30) Foreign Application Priority Data
Mar. 15, 2018 (JP) 2018-048464

(51) Int. Cl. G06F 3/06; G06F 12/14; G06F 9/54; G06F 9/50; G06F 9/455; G06F 16/907

(52) U.S. Cl. CPC G06F 3/0622; G06F 3/0658; G06F 12/14; G06F 9/545; G06F 2009/45583; G06F 3/0635; G06F 9/5077; G06F 9/45558; G06F 16/907; G06F 3/0644

(57) ABSTRACT

A storage device includes a storage unit, an interface that is physically connectable to a network, and a controller. The controller is configured to establish a first logical communication path via the interface in a first communication software layer, through which data is read from and stored in the storage unit, and a second logical communication path via the interface in a second communication software layer higher than the first communication software layer, through which meta information for controlling access to the storage unit is communicated.

### CROSS-REFERENCE TO RELATED APPLICATION

This application is based upon and claims the benefit of priority from Japanese Patent Application No. 2018-048464, filed Mar. 15, 2018, the entire contents of which are incorporated herein by reference.

### FIELD

Embodiments described herein relate generally to a storage device, a control method, and a control program.

### BACKGROUND

A storage device which is connectable to a communication device may be connected to a network through the communication device. It is desirable to improve convenience of using the storage device in various contexts.

### DESCRIPTION OF THE DRAWINGS

FIG. 1 depicts a storage device according to a first embodiment.

FIG. 2 depicts aspects of a control flow and information flow in the storage device according to the first embodiment.

FIG. 3 illustrates a connection between the storage device and a communication device.

FIG. 4 depicts aspects of the information flow in a connection between the storage device and the communication device.

FIG. 5 illustrates a use case of a communication application according to the first embodiment.

FIG. 6 depicts a storage device according to a second embodiment.

FIG. 7 is a flowchart illustrating aspects of an operation of an access controller according to the second embodiment.

FIG. 8 depicts aspects of an access control table managed by the access controller according to the second embodiment.

FIGS. 9A, 9B, and 9C illustrate an example form of a communication application according to various modifications of the first embodiment and the second embodiment.

FIGS. 10A and 10B depict aspects of the communication application according to modifications of the first embodiment and the second embodiment.

FIGS. 11A to 11D illustrate a use case of the communication application according to modifications of the first embodiment and the second embodiment.

FIGS. 12A and 12B illustrate another use case of the communication application according to modifications of the first embodiment and the second embodiment.

FIGS. 13A and 13B illustrate yet another use case of the communication application according to modifications of the first embodiment and the second embodiment.

### DETAILED DESCRIPTION

Embodiments provide a storage device with improved convenience, and a control method and a control program thereof.

In general, according to one embodiment, a storage device includes a storage unit, an interface that is physically connectable to a network, and a controller. The controller is configured to establish a first logical communication path via the interface in a first communication software layer, through which data is read from and stored in the storage unit, and a second logical communication path via the interface in a second communication software layer higher than the first communication software layer, through which meta information for controlling access to the storage unit is communicated.

Hereinafter, a storage device according to embodiments will be described with reference to the accompanying drawings. However, the present disclosure is not limited to the depicted embodiments.

### First Embodiment

A storage device according to the first embodiment is connectable to a communication device. For example, in so-called edge computing or fog computing systems, a method including executing a service and processing data in a communication device is distributed. Currently, an increasing number of communication devices incorporate storage devices. In some instances, a home broadband router or the like may include a USB port and thus could provide sharing of any storage unit connected to the USB port across a network.

However, when a storage device connected to such a communication device operates to store/retrieve information it may not be possible for another device connected to the network to access the storage device, or the communication functions of the communication device may be inhibited.

This method may require the communication device to be designed in advance in consideration of the provision of a connection to the storage device, or alternatively software may be added subsequently. In order to cope with this situation, designing, mounting, and verification are required in consideration of many possibilities that may occur when a device is connected, which may lead to an increase in development cost. In a communication device such as a wireless LAN access point, it is difficult to flexibly redesign the device and/or its software because the communication device is initially designed and mounted with such a precise delineation of operation contents.

Therefore, in the present embodiment, in addition to a logical communication path to a storage unit in a first communication layer via an interface, a logical communication path to the storage unit in a second communication layer higher than the first communication layer via the interface is incorporated in the storage device. Thus, the function as a storage unit and the function of providing a network service can be provided to improve the convenience of the storage device. The first communication layer includes, for example, a physical layer or a network interface layer, and the second communication layer includes the network layer or the Internet layer.

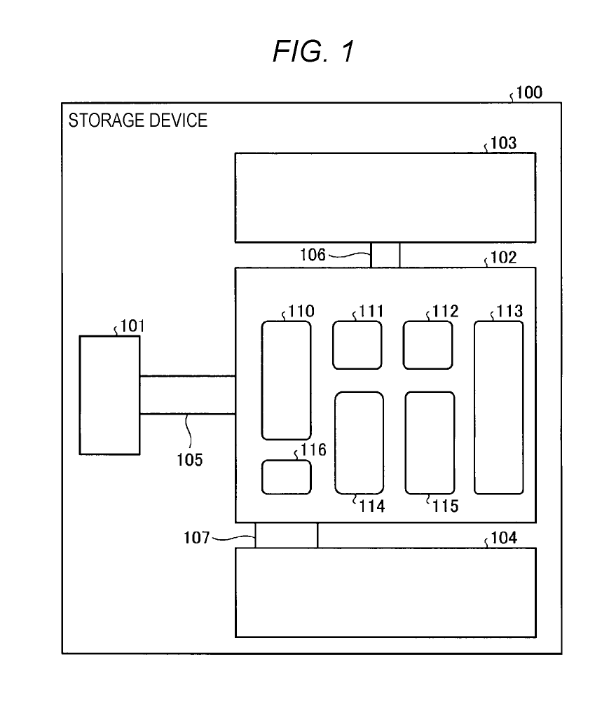

Specifically, a storage device 100 is configured as illustrated in FIG. 1. FIG. 1 is a functional block diagram illustrating the configuration of the storage device 100. FIG. 1 assumes a case where functions are provided by execution of operations of a calculation unit such as a processor.

The storage device 100 includes an interface 101, a processor 102, a memory 103, and a storage unit 104. The storage unit 104 is a physical storage device of any type, including most commonly a magnetic storage device and a semiconductor storage device.

The interface 101 is capable of physically connecting the storage device 100 to an external device, such as a communication device or the like. The interface 101 may have a connector which conforms to a standard such as USB or a PCI Express, or otherwise may conform to a communication standard for a backplane such as Converged Ethernet or 10GBASE-KR. The storage device 100 is connected to an external communication device (e.g., a router, a switching hub, a wireless LAN access point, etc.) via the interface 101.

In the present specification, the interface 101 is generally considered to include a physical connection point with the outside (a connector, etc.).

The processor 102 is responsible for the overall operation of the storage device 100. The processor 102 includes or otherwise provides a controller appropriate for the interface 101 (e.g., a USB controller, a PCI Express controller, etc.), a controller appropriate for the memory 103 (e.g., a memory controller for the memory 103), and a controller appropriate for the storage unit 104 (e.g., a memory controller for the storage unit 104). The processor 102 is connected to the interface 101 via a bus 105, to the memory 103 via a bus 106, and to the storage unit 104 via a bus 107.

The memory 103 temporarily stores a program executable or executed by the processor 102 and data used by the program during execution. As the memory 103, a dynamic random-access memory (DRAM), which is a volatile memory, may be used, or a nonvolatile memory, such as a magnetoresistive random-access memory (MRAM), a spin-transfer torque (STT)-RAM, or a resistive random-access memory (ReRAM), may be used, or a combination of a volatile memory and a nonvolatile memory may be implemented.

The storage unit 104 stores a program to be executed by the processor 102, data used by the program, and the like. For the storage unit 104, a large-capacity nonvolatile memory, such as a NAND type flash memory, is used. When a NAND type flash memory is used, control information and data are exchanged through an interface for the memory called a memory controller. Since the present specification is not dependent on the function of the memory controller, the description of the detailed functions of this aspect is omitted for the sake of simplicity.

Multiple pieces of software may be executed inside the processor 102. The pieces of software may include a device driver 110, a device driver 111, a device driver 114, a communication protocol stack 112, a communication application 113, a file system 115, and a device driver 116.

The device driver 110 is software which controls the operation of the interface 101.

The device driver 111 is software which configures a logical network interface for the device driver 110. The device driver 111 is also referred to as a logical network interface driver 111.

The device driver 114 is a driver which configures a logical storage device for the device driver 110. The driver 114 is also referred to as a logical storage device driver 114.

The communication protocol stack 112 operates on the device driver 111 constituting the network interface. The communication protocol stack 112 includes, for example, a TCP/IP stack.

The communication application 113 uses the communication protocol stack 112. The communication application 113 provides a service via the network to a communication partner connected via the interface 101.

The file system 115 operates in conjunction with the driver 114 constituting a logical storage device. The file system 115 provides input/output (I/O) of various files for the communication application 113.

The device driver 116 is a device driver for the physical storage unit 104. The device driver 116 is also referred to as a physical storage device driver 116.

Hereinafter, a case where a USB (Universal Serial Bus) protocol is used as the protocol of the interface 101 will be presented as an example. In this case, the device driver 110 is responsible for the control of the USB controller and the basic processing that does not depend on the upper usage type. The logical network interface driver 114 corresponds to a device driver which implements a communication device class, and the logical storage device driver 116 corresponds to a device driver which implements a USB mass storage class.

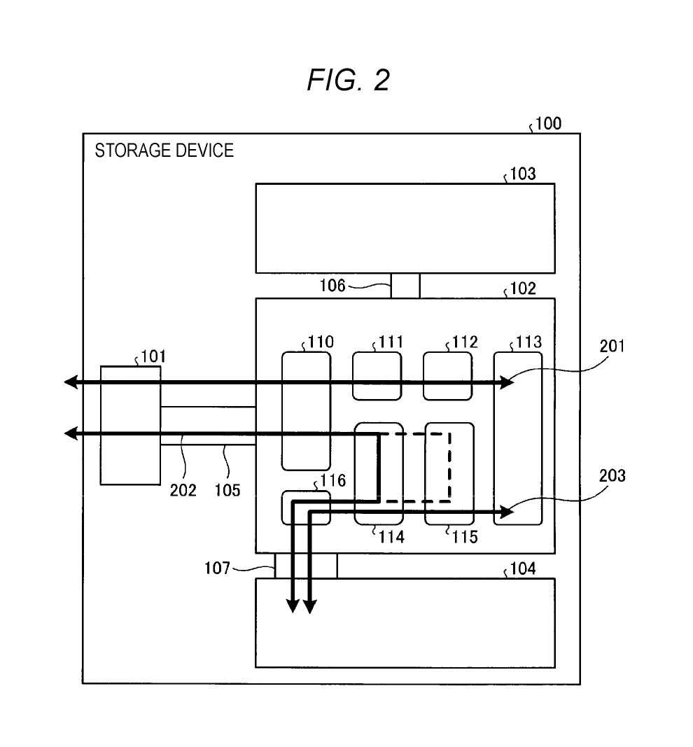

The flow of control and information among the respective elements of the storage device 100 is illustrated in FIG. 2. FIG. 2 is a diagram illustrating the flow of control and information in the storage device 100.

There are basically three flows (flow 201, flow 202, flow 2030 in the storage device 100. The flow 201 is a flow by which an external node (e.g., a communication device) utilizes a network service function. The flows 201 and 203 are flows by which reading and writing of the storage unit 104 are performed in a second communication layer (the network layer and the Internet layer). The flows 201 and 203 correspond to the logical communication path connected to the storage unit in the second communication layer via the interface 101.

The flow 201 corresponds to a flow of control information and data performed by the communication application 113 using a communication protocol such as TCP/IP with an external node. Communication may be started from the communication application 113 or communication may be started by receiving control information and data transmitted from an external communication node. The information/data to be transmitted or received is temporarily stored in the memory 103.

The communication application 113 reads or writes what is stored in the storage unit 104 as needed. The reading or writing with respect to the storage unit 104 is performed via the file system 115 or the physical storage device driver 116. This is indicated as the flow 203.

Further, the flow arrows in FIG. 2 indicate the transmission of control information or data without distinction. However, the control information may be specifically indicated by the arrows passing through the respective elements. Data in some instances may be direct memory access (DMA) transferred between the interface 101 and the memory 103, and likewise a transfer may be performed between the interface 101 and the storage unit 104. At that time, each element refers to the data transmitted to the memory 103 at the necessary timing. For example, the communication protocol stack 112 or the communication application 113 starts up the processing when the received data is recorded in the memory 103.

The flow 202 is a flow by which an external node uses the storage device 100 for storage, and reads and writes the storage unit 104 from the first communication layer (a physical layer or a network interface layer). The external node accesses a storage device implemented by the USB device driver 110 and the logical storage driver 114, and accesses the storage unit through the physical storage device driver 116. There are two storage unit 104 access possibilities 1) through the file system 115 and 2) without the file system 115, and this second option is expressed by the dotted lines associated with the flow 202. The flow 202 corresponds to a logical communication path connected to the storage unit in the first communication layer via the interface 101.

The flow 203 occurs when the communication application 113 accesses the storage unit 104 to perform reading and writing. The storage unit 104 can be accessed through the file system 115, the logical storage driver 114, and the physical storage driver 116.

By implementing a logical interface and a device on one connector (e.g., physical interface 101) as described above, control information and data exchange with the communication device serving as a connection destination via the network, and reading and writing of data are respectively implemented. Hereinafter, a processing that characterizes the storage device 100 will be described in accordance with an example usage form of the storage device 100.

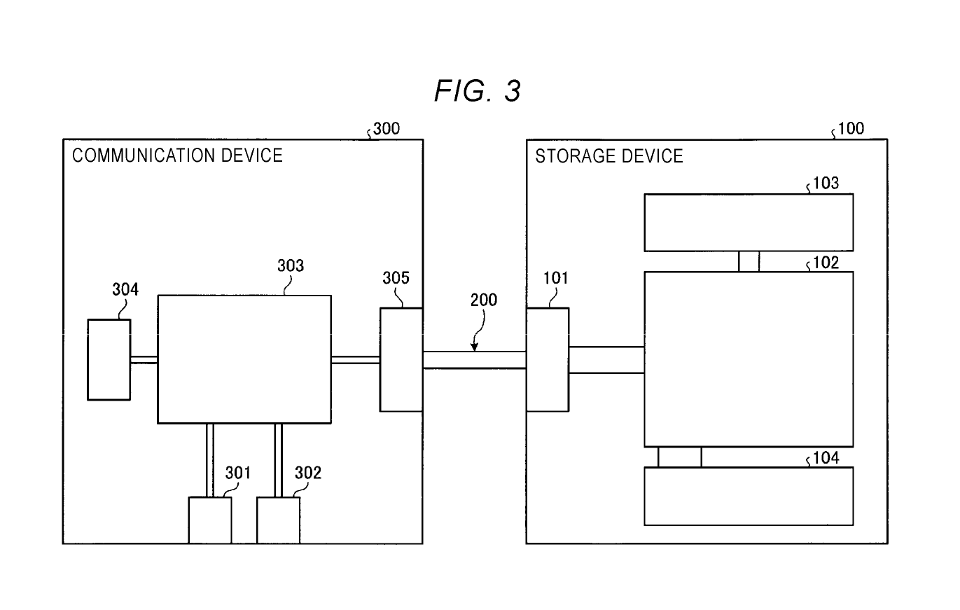

In one example, the storage device 100 is connected to the communication device 300, as illustrated in FIG. 3.

The storage device 100 is physically connected to the communication device 300 via a communication line 200. The communication line 200 may be, for example, a serial communication line or a parallel communication line. The communication device 300 includes a communication interface (I/F) 301, a communication interface (I/F) 302, a processor 303, a memory 304, and an interface 305.

The interface 305 corresponds to the same interface standard as the interface 101 of the storage device 100 and may thus be communicably connected to the interface 101 via the communication line 200.

The processor 303 is responsible for a communication processing performed by the communication I/Fs 301 and 302. The processor 303 may use the memory 304 as a work area for software executing on the processor. The communication I/Fs 301 and 302 perform a communication processing and play a role of connecting to a wired or wireless network between the communication device 300 and the storage device 100. One or both of the communication I/F 301 and the communication I/F 302 may be bridge connected in the communication device 300 to operate as a bridge (a wireless LAN access point), and the communication I/F 301 and the communication I/F 302 may be allocated with different subnets to operate as a router. The processor 303 performs a processing of packets transmitted and received via the network between the communication I/Fs 301/302 and the interface 305. It is also possible to transmit information stored in the storage unit 104 to the network by executing a communication application in the processor 303 or to receive information from a node connected to the network and store the information in the storage unit 104.

FIG. 3 omits illustration of the internal structure of the communication device 300 and the function of the software for the sake of simplicity. For example, it may be necessary to maintain a device driver corresponding to the physical interface, a device driver of the logical interface configured on the physical interface, a file system, and the like as illustrated in FIG. 1.

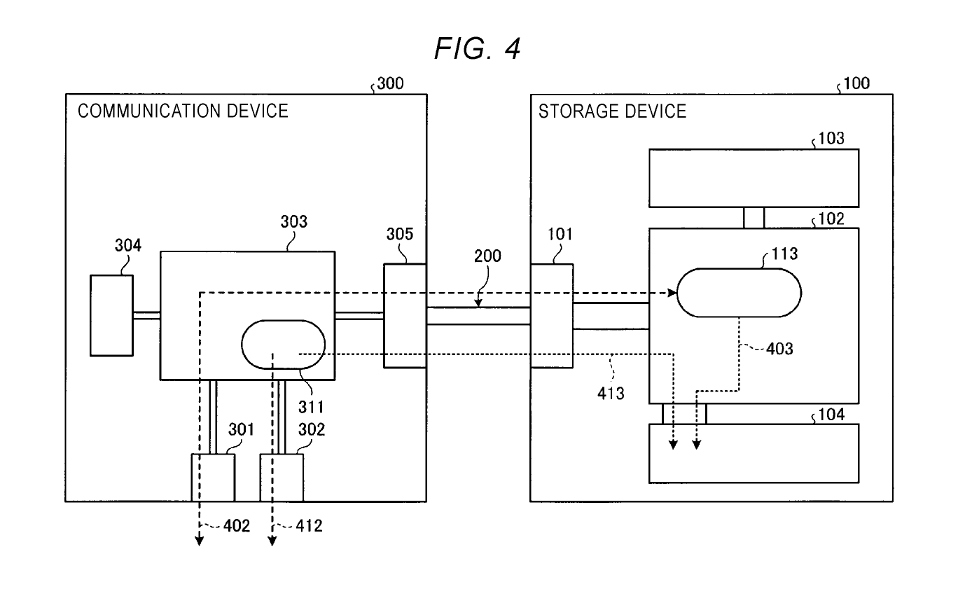

A flow of information when the storage device 100 is connected to the communication device 300 is illustrated in FIG. 4.

FIG. 4 illustrates a communication application 113 that operates on the storage device 100 and a communication application 311 that operates on the communication device 300. The communication application 113 is an application that performs communication such as TCP/IP through the logical network interface driver 111 (see, e.g., FIG. 2). The communication application 311 is an application that accesses the storage unit 104 through the logical storage device driver 114 of the storage device 100 (see, e.g., FIG. 2). The communication application 113 may control a flow 402 and a flow 403. The flow 402 is a flow of packet communication performed through the communication I/Fs 301/302, the interface 305, the communication line 200, and the interface 101. The flow 403 is a flow of storage I/O when the communication application 113 reads and writes data on the storage unit 104. Similarly, the communication application 311 may control a flow 412 and a flow 413. The flow 412 is a flow of packet communication performed through the communication I/F 301/302. The flow 413 is a flow of storage I/O when reading and writing data on the storage unit 104 through the interface 305, the communication line 200, and the interface 101.

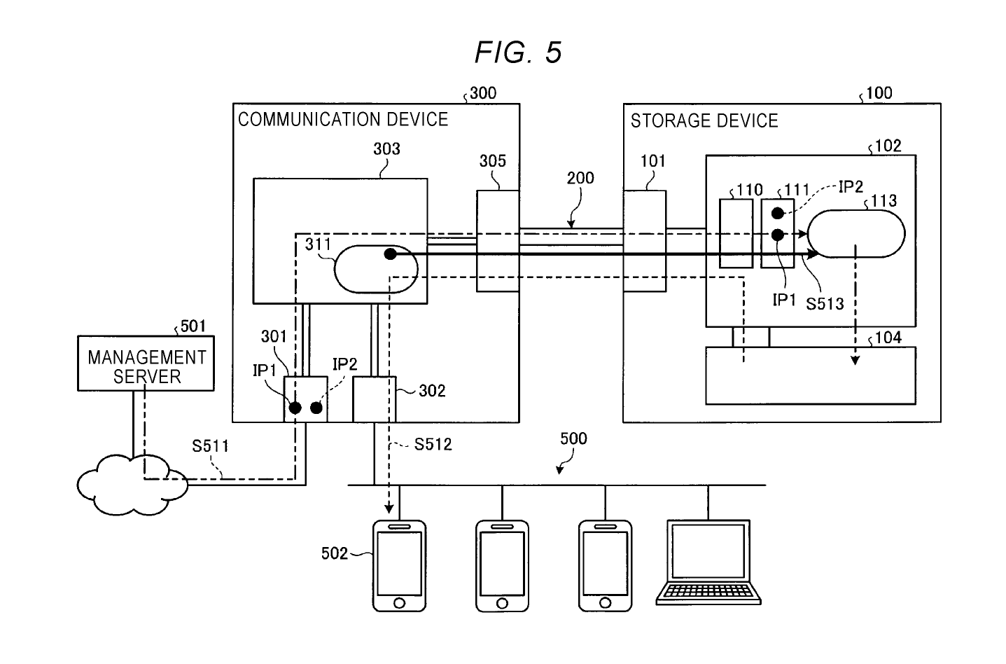

Examples of the uses of the two communication applications 113 and 311 will be described with reference to FIG. 5.

FIG. 5 illustrates a case in which a moving image file stored in the storage unit 104 is distributed to a terminal 502 connected to the network 500. This operation includes three sequences S511, S512, and S513).

The sequence S511 is a sequence which the moving image file to the storage unit 104. The sequence S512 is a sequence which transmits the stored moving image file from the storage unit 104 to a terminal 502 connected to the network 500. The sequence S513 is a sequence related to maintenance processing, such as setting or confirming an access right to a moving image file, collection of a log of transmissions of a moving image file, or the like.

The roles of the communication application 113 and the communication application 311 in handling each of the sequences S511 to S513 may be varied in some aspect from those described in this example embodiment.

The sequence S511 is performed by the communication application 113 via a network. A management server 501 that manages the arrangement of a moving image file communicates with a communication application 113, and an appropriate moving image file is provided from the management server 501. In order to implement this, the management server 501 transmits a connection request to an IP address allocated to the logical interface of the storage device 100. Hereinafter, this IP address referred to as IP1. In FIG. 5, it is assumed that IP1 is also allocated to the communication I/F 301 for proxy transmission/reception in addition to the logical interface. When there is no problem in the network, a packet having IP1 as the destination IP address reaches the communication device 300 via the communication I/F 301. Upon detecting the packet, the communication device 300 transmits the packet to the interface connected to the storage device 100. If the communication I/F 301 is a wired LAN, the received packet is in a frame format of the wired LAN (e.g., IEEE802.3 format) and is encapsulated and transmitted in the frame of the physical interface while maintaining the appropriate format. If a USB is used as an interface, a frame of a wired LAN format to which a USB header is added is transmitted.

Further, when the communication device 300 is in a format of capable of connecting multiple storage devices 100 or when multiple IP addresses IP1 and IP2 are allocated to the logical network interface 111 of the storage device 100, the communication I/F 301 also maintains these IP addresses. If required, a management table may be held in the communication device 300 that correlates the IP addresses to the identifier of the interface serving as the transmission destination (e.g., the MAC address of the logical network interface 111 or the identifier of the physical interface). This structure may be independently constructed on the communication device 300 side or the management table may be provided by transmitting the necessary information from the storage device 100 to the communication device 300.

Upon receiving the encapsulated wired LAN frame in the header of the physical interface, the storage device 100 first removes the header of the physical interface from the device driver 110 and determines which of the logical devices multiplexed on the physical interface corresponds to which device. In the present embodiment, the logical network interface device and the logical storage device are implemented on the interface 101. However, since here the received frame is the format of a wired LAN frame, the received frame is transmitted to the logical network interface driver 111. The logical network interface driver 111 interprets the received frame as a wired LAN frame (IEEE 802.3) and confirms that the destination MAC address matches the MAC address of the logical network interface driver 111. If there is no match, the frame is discarded.

When the destination MAC address matches the logical network interface 111, the frame is forwarded to the communication protocol stack 112. The communication protocol stack 112 performs a TCP/IP processing (by confirming that the destination IP address is IP1 allocated to the logical network interface), and transmits the connection request from the management server 501 to the communication application 113. Thereafter, a connection is established in the management server 501 and the second communication layer of the communication application 113 after a packet transmission/reception.

After the connection between the management server 501 and the communication application 113 is established, a processing is performed based on a predetermined order between the management server 501 and the communication application 113. The management server 501 transmits the moving image file to the storage device 100, and after the communication application 113 receives the moving image file, the moving image file is finally stored in the storage unit 104 while using the memory 103 as a buffer. When the moving image file is stored, the communication application 113 uses the file I/O provided by the file system 115.

Further, meta information that controls aspects related to use of the moving image file may be transmitted using the sequence S511. The meta information may also include the information that is necessary to control access to the storage unit 104 via the flow 202 (see, e.g., FIG. 2). For example, the meta information may include an upper limit on the number of times the file is accessible), a limit on the time for which the file is accessible), an expiration time after which the file is no longer accessible or transferrable, a type of reading and writing to be utilized, process information, user information, etc. By using this function, it becomes possible to remotely control the information to be stored and how and when the information is accessible. A simple control of whether the information is accessible or not can be implemented by the logical storage driver 114 or the file system 115. A more complex control on access, such as user authentication, or the like, will be described in a second embodiment.

The sequence S512 transmits the moving image file to the terminal 502 on the network 500 via the communication device 300. The transmitting application is a communication application 311 which operates on the communication device 300.

The communication application 311 receives a request for acquisition of a moving image file from the terminal 502 on the network 500. The moving image file to be transmitted is specified by analyzing an identifier included in the request. When the target is specified, the communication application 311 checks whether a file having the identifier is stored in the storage unit 104. This operation is performed according to the flow 413 illustrated in FIG. 4, which corresponds to communication application 311→interface 305→interface 101→processor 102→storage unit 104.

The logical storage device driver 114 of the storage device 100 (see, e.g., FIG. 2) may provide an exclusion control function to limit access from the storage device 100 or access from the communication device 300. For example, when the sequence S511 illustrated in FIG. 5 is executed, the access based on the sequence S512 is shut down or put on standby. In addition, it is conceivable that the time for executing the sequence S511 may be specified in advance, the sequence S511 is permitted only for a fixed time, and only the sequence S512 is allowed outside the specified time. When the exclusion control is performed to prevent access, the storage unit 104 may act as if still connected or may act as if disconnected.

The snapshot function provided by the file system 115 (see, e.g., FIG. 2) may be utilized instead of the exclusion control. At that time, both the communication device 300 and the storage device 100 perform an access via the file system 115. Since the write processing is required in the sequence S511, the storage device 100 is made to be referred to as a normal file system. However, since the write processing is not required in the sequence S512, a snapshot is periodically generated inside the storage device 100 and the snapshot is disclosed to the communication device 300.

Furthermore, the generation timing of the snapshot may be executed at a regular timing irrespective of the sequence S511 as described above, or may be synchronized with the execution timing of the sequence S511. When the sequence S511 is started up irregularly, another sequence S511 may be generated when the sequence S511 ends.

When the requested file does not exist, the communication application 311 transmits an error response to the requesting terminal 502. When the requested file exists, the file is read through the same flow 413 (see, e.g., FIG. 4) immediately before. When reading, the physical storage device driver 116 or the logical storage device driver 114 of the storage device 100 (see, e.g., FIG. 2) may use the memory 103 as a buffer. In any case, the specified moving image file is read from the storage unit 104, and the communication application 311 performs an appropriate processing (specifically, a TCP/IP processing, etc.) and sends the file to the terminal 502 of the request source.

The sequence S513 is further divided into two subsequences S513a and S513b.

The first subsequence S513a operates on a collection of information stored and managed by the communication application 311. The communication application 311 on the communication device 300 maintains a distribution log of the executed moving images, and the communication application 113 on the storage device 100 periodically collects the log. Both the communication applications 113 and 311 may communicate with each other via TCP/IP during the collection of the log. Further, the log may be stored in the storage unit 104 in the form of a file, and the communication application 113 may refer to the stored log.

The second subsequence S513b operates to transmit the information collected by the communication application 113 of the storage device 100 to the outside. The communication application 113 periodically communicates with the management server 501 to obtain management information or transmit collected logs. This processing is implemented as communication via the logical network interface as for the first subsequence S513a.

For the sequences S511 to S513 described above, the logical storage device driver 114 (see, e.g., FIG. 2) is used in the sequence S512 in which the communication device 300 executes a lot of read processing, and a logical network interface is used in cases where fine control is required. By making the storage unit 104 act in the interface between the communication device 300 and the storage device 100, the communication of the terminal device 502 is terminated in the communication device 300 so that the overhead of the entire communication processing may be reduced. However, flexibility of operation is important for fine control such as installation of moving images and collection of logs. Standard communication protocols are suitable for this.

As described above, in the first embodiment, plural logical interfaces (plural logical communication paths) are constructed on one physical interface 101 in the storage device 100 so that the logical interface (logical communication path) used for the access processing to the storage unit 104 may be distinguished and used according to the communication characteristics. Thus, the storage unit 104 may be easily connected to the communication device 300, and an application may be added to the communication device 300 side or the storage device 100 side according to the usage. As a result, it is possible to grant the storage device 100 a function of providing storage and a function of providing a network service, thereby improving the convenience of the storage device 100. That is, the flexibility of the storage device 100 in the network may be improved, and a network attached storage (NAS) system including the storage unit 104 may be constructed more easily.

### Second Embodiment

The storage device 100k according to the second embodiment will be described. Hereinafter, descriptions will be made mainly of the portions different from the first embodiment.

In the second embodiment, a portion related to the meta information and the control thereof is added.

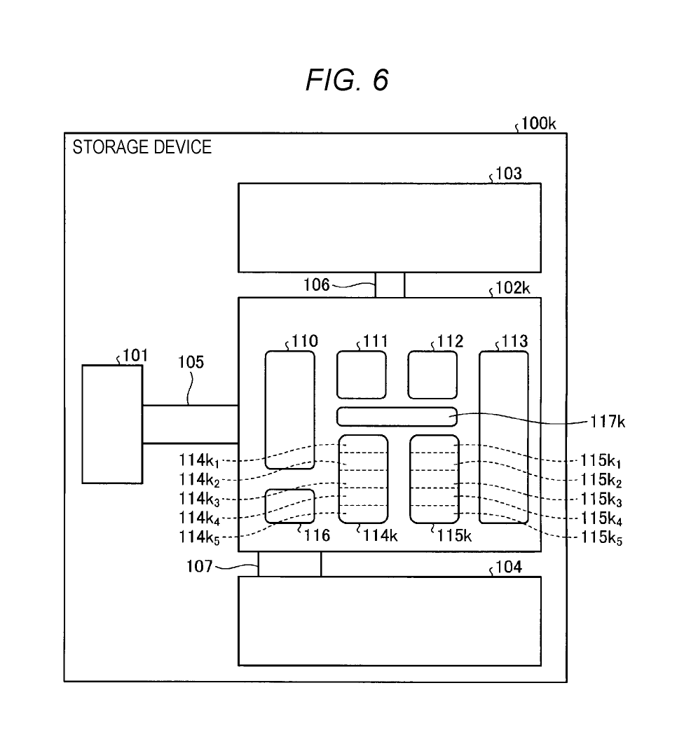

Specifically, as illustrated in FIG. 6, the storage device 100k is different from the first embodiment in the software operating in the processor 102k. FIG. 6 is a diagram illustrating the configuration of the storage device 100k. Multiple pieces of software capable of operating in the processor 102k include a logical storage device driver 114k in place of the logical storage device driver 114, a file system 115k in place of the file system 115 (see, e.g., FIG. 1), and also an access controller 117k.

The logical storage device driver 114k is divided into elements 114k1 to 114k5 in order to implement an access control to the storage unit 104 based on the meta information. The file system 115k is divided into elements 115k1 to 115k5 in order to implement an access control to the storage unit 104 based on the meta information. Each of the divided elements 114k1 to 114k5 and 115k1 to 115k5 may provide an outside communication device or an application 113 in the device itself with one or more partitions having a different access control and different functions for the storage unit 104. The file system 115k provides an independent file system for each partition. The access controller 117k controls the logical storage device driver 114k and the file system 115k based on the meta information to have a function of logically reconfiguring an appropriate partition for the designated access control (an appropriate logical storage unit) in the storage unit, and a function of taking charge of access control for the partition (the logical storage unit).

In FIG. 6, five is adopted as the total number of divisions, but there are no particular restrictions on the total number of divisions. The number of divisions may be less or greater than 5. In FIG. 6, it is shown that there are multiple functional elements by explicitly dividing into depicted elements with dashed lines. However, in practice, it may be possible to provide several partitions by software using a single element. It may be that the elements are divided into fewer than the total number of partitions that are provided and some of the divided elements function with multiple partitions.

For the flows 201, 202, and 203 represented in the first embodiment, approximately the same operations are performed. However, in the second embodiment, an access control based on the meta information is added to the flow 201 and the flow 202.

The information and the meta information are stored by the flow 201 in the storage unit 104 in the same general manner as in the first embodiment. The access controller 117k confirms whether the meta information is received, and also confirms the contents of the access control when received. When the newly designated contents match the existing partitions or it is possible to cope using only the existing partitions, a processing for changing the partitions is not performed. However, when it is determined that it is not possible to cope using the existing partitions, another partition is generated.

This determination may be made by the access controller 117k based on the corresponding meta information. For example, this determination may be specified in the program of the access controller 117k, or the condition table stored in the memory 103 may be referred to in making the determination. The condition table is assumed to be installable using the second logical communication path. Possible determination conditions are described in the following aspects (1) to (3):

(1) Whether a subject that accesses the storage unit 104 is the same as the subject of the existing partition. The subject in this context may be a communication device or an application 113 connected via the interface 101, or a user/user group using the communication device or the application 113.

(2) Whether a write to the storage unit 104 is requested.

(3) Whether a special processing is requested for the information stored in the storage unit 104 (e.g., whether a processing for encrypting/decrypting the information with a separately designated key is required).

The determination conditions are not limited to (1) to (3). Here, it is assumed that the control over the number of times the stored information can be accessed and a start timing (a time at which access is permitted or not) is implemented by the access controller 117k independently from the generation of the partition.

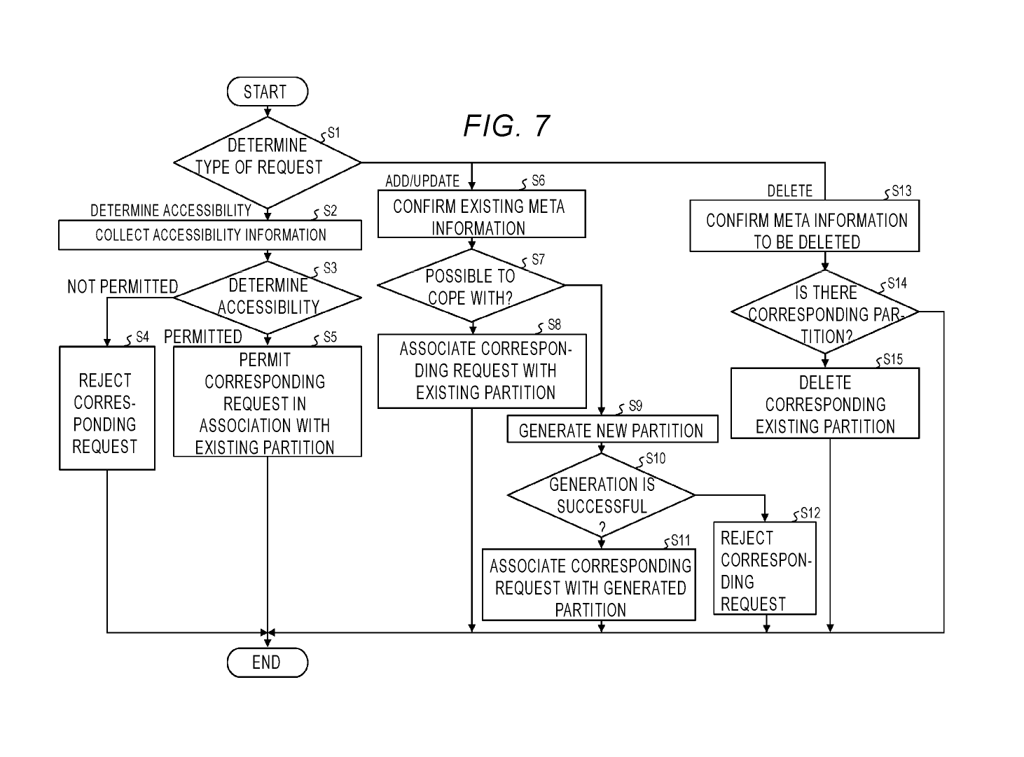

Further, an operation flow when the request is received by the access controller 117k is illustrated in FIG. 7. FIG. 7 is a flowchart illustrating the operation of the access controller 117k.

The access controller 117k determines the type of the request (S1). Requests are roughly classified into two types. One type is to determine accessibility to the storage unit 104, and the other type concerns the addition, deletion, and update of meta information.

The accessibility determination is a processing of determining whether it is possible to access the storage unit 104 requested by the interface 101 or the application 113. This request may be implemented to occur only once at a time when the storage unit 104 or the partition therein is accessed for the first time, or may be implemented to occur for each access. In the former case, for example, an accessibility determination is performed when a partition is mounted, and in the latter case, a determination is performed each time an instruction that requires an access is executed. The former case has a smaller overhead, but a more accurate accessibility determination may be performed with the latter case.

The access controller 117k collects accessibility information when the type of the request is an accessibility determination (“accessibility determination” in S1) (S2), and when the access is impossible due to the partition being already in use or the like (“not permitted” in S3), the access controller 117k returns to the access requestor that the corresponding request is rejected (S4). When the access is possible such as when the partition is an idle partition (“permitted” in S3), the access controller 117k permits the corresponding request in association with an existing partition (S5).

The addition, deletion, and update of the meta information are processing for adding, deleting, and updating the corresponding meta information with respect to the information stored in the storage unit 104. The processing for an addition is performed before the information is stored in the storage unit 104, and the information is stored in the appropriate partition only after the addition processing. In contrast, the deletion and the update processing are performed on already stored meta information.

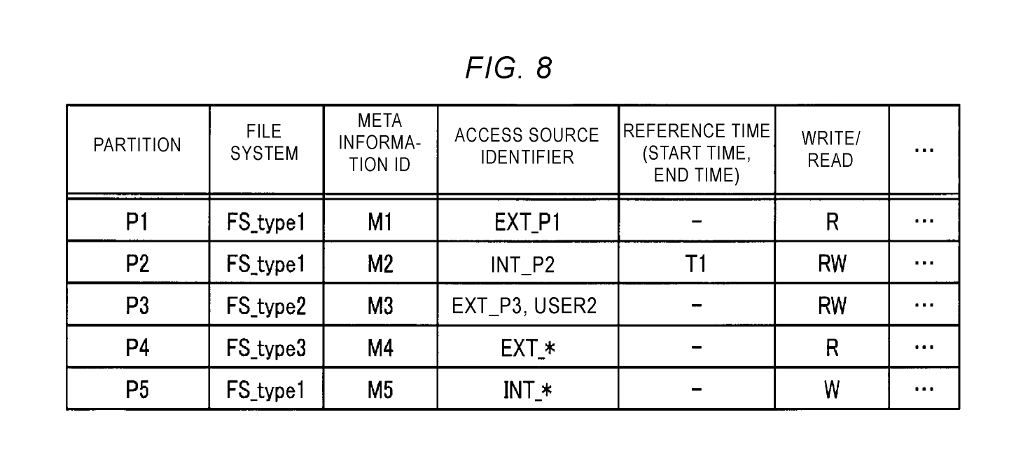

The processing for adding meta information is essentially divided into two aspects. One aspect the processing is that when the access control defined by the meta information is implemented by an existing partition (e.g., the permitted access requestor is the same, there is no restriction on the time at which reference is possible, etc.). In this case, generating a new partition is unnecessary and the existing partition is used as it is. The access controller 117k associates the designated meta information and the access to the storage unit 104 using the meta information. This association is managed by establishing an access control table in the access controller 117k (see, e.g., FIG. 8). In other examples, the correspondence relationship may be sent to the access requestor. For example, the identifier of the corresponding partition is sent by an implementation that allows direct access to the partition.

The second case is the case of not being able to utilize the existing partition. In this case, the access controller 117k generates a new partition and manages the corresponding meta information in association with the partition. When a new partition may not be generated, a response indicating rejection of the access is returned. A situation in which a partition may not be generated may be a case where the logical storage device driver 114k or the file system 115k has already met or exceeded the allowable number of partitions or a case where the storage unit 104 does not have sufficient free capacity remaining.

The processing when the meta information is updated is basically the same as the case of addition. As a result, when it is not possible to cope using the existing partition, a new partition is allocated. At that time, the information contained in an existing partition may be copied over or a partition that contains nothing may be generated.

When the type of the request is an addition/update (“add/update” in S1) , the access controller 117k confirms the existing meta information (S6). When it is possible to cope using the existing partition (“YES” in S7), the access controller 117k permits the corresponding request in association with the existing partition (S8). The access controller 117k generates a new partition when it is not possible to cope using the existing partition (“NO” in S7) (S9), and permits the corresponding request in association with a new partition when the new partition has been generated (“YES” in S10) (S11). When the new partition may not be generated (“NO” in S10), the access controller 117k returns to the access requestor that the corresponding request has been rejected (S12).

When deleting the meta information, it is confirmed whether there is a partition corresponding to the meta information. When there is such a partition, the partition is deleted. the partition may be deleted immediately or the partition may be deleted a predetermined time from the deletion request. Any on-going access to the partition may be forcibly terminated as an error and the partition may be deleted immediately. In any case, the processing is executed so that the partition(s) corresponding to the meta information is deleted.

The access controller 117k confirms the meta information to be deleted (S13). When there is a partition corresponding to the meta information (“YES” in S14), the corresponding partition is deleted (S15). When there is no partition corresponding to the meta information (“NO” in S14), the access controller 117k ends the processing.

The control of meta information is performed in accordance with the flow 201 illustrated in FIG. 2. In other words, the control is implemented by giving some of the function of the communication application 113 to the access controller 117k or otherwise giving some of the function associated with receiving information exchanged between the communication application 113 and the outside to the access controller 117k. In any case, the meta information of the storage device 100k can exceed the physical connection range and be controlled from the outside. For the control of the meta information from the outside, the communication associated with transmitting and receiving the meta information may be encrypted or the communication partner may be securely authenticated. These encryption and/or authentication operations may be implemented as functions of the communication application 113.

Further, performance of these operations may be limited to a communication device 300 that directly connects to the transmission source of the meta information (see, e.g., FIG. 3). When implementing this restriction, information may be sent in using both the first logical communication path and the second logical communication path. For example, the meta information can be divided and transmitted on two communication lines or an encryption key is sent on the first logical communication path after passing the encrypted meta information using the second logical communication path.

The access control table managed by the access controller 117k has, for example, the configuration illustrated in FIG. 8. FIG. 8 is a diagram illustrating the configuration of the access control table managed by the access controller 117k.

The access control table illustrated in FIG. 8 maintains five entries corresponding to the number of divisions of the logical storage device driver 114k and the file system 115k having five divisions illustrated in FIG. 6. Each of the entries includes a corresponding partition, a file system, an identifier of meta information (meta information ID), an access source identifier, a reference time, and the like. The information constituting the entry is an example, and it is not necessarily required to for all such information to be maintained for each entry. Additionally, other information may be included in an entry (e.g., the partition size or the like may be maintained).

It is assumed that “FS_type1” and “FS_type2” correspond to identifiers of different file systems that are actually used.

The meta information ID is an identifier that may uniquely specify the meta information in the storage device, and is allocated by the access controller 117k. Further, in FIG. 8, the term “EXT_P1” indicates process P1 of the device connected via the interface 101, the term “INT_P2” indicates process P2 which is the communication application 113 operating in the storage device, the term “EXT_P3, USER2” indicates process P3 that operates on an external device, and the user thereof is USER2, and the terms “EXT_*” and “INT_*” indicate any process operating on an external device and any communication application operating in a storage device, respectively. When more detailed information such as a process name, a process ID, and the user information of a communication source is used in addition to the information of “outside of the storage device” and “inside of the storage device,” such information may also be used for the access control.

The access controller 117k includes a unit for obtaining and determining access control information, and executes such a unit to communicate on the second logical communication path for such things as managing the information of the communication partner user received from the communication application 113 (such as a user name and a password), querying information from an external authentication server, etc. Furthermore, a functions necessary for operating with an external device may be provided such as checking the identification information of an application operating on the external device and transmitting information to the storage device 100k.

A partition generally refers to a portion of a logical partition of a storage unit. However, in the present embodiment the term “partition” encompasses a broader meaning than logical partitions of the storage unit. Specifically, as used in this description partition includes certain areas implemented by software within a logical area, such as reservation/isolation/divisions of areas of a namespace, a virtual disk that is created by reference to a disk image file stored on the storage unit, a snapshot of the area that is already recognized as a “partition,” a combination of a snapshot and differential information, and the like. Based on this definition an area allocated to a portion of the physical storage unit 104 may be referred to as a first partition in a readable/writable state from the communication application 113 of the storage device 100k and as can a snapshot of this partition in a readable state to an external device, such as the communication device 300, the management server 501, etc. illustrated in FIG. 5.

As described above, in the second embodiment, information that controls the access to the storage unit 104 is transmitted and received, and the access control based on this information is performed by using the second logical communication path that may operate in the higher communication layer of the two logical communication paths configured on the physical interface 101. Thus, the control based on a service operating on the storage device 100k is implemented in the storage device 100k physically connected to the communication device 300.

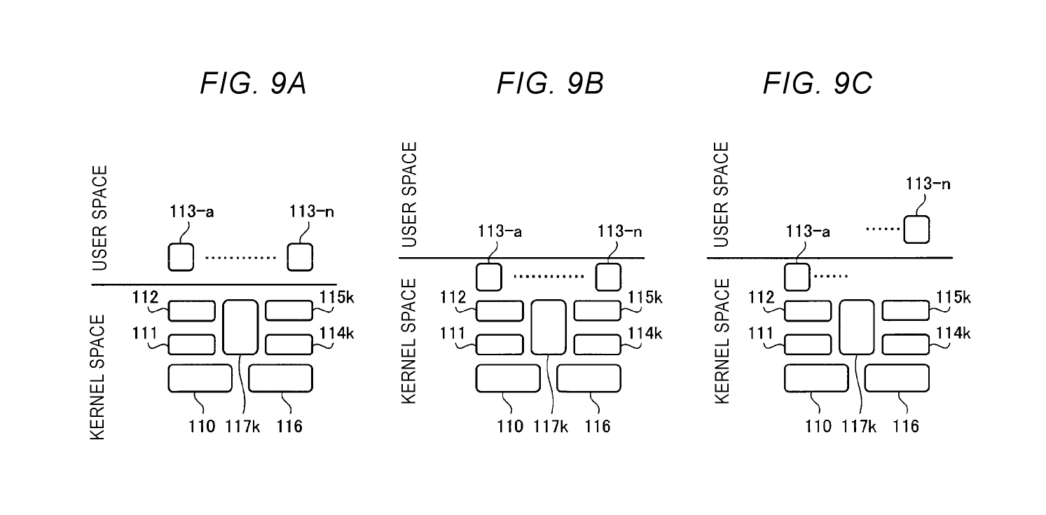

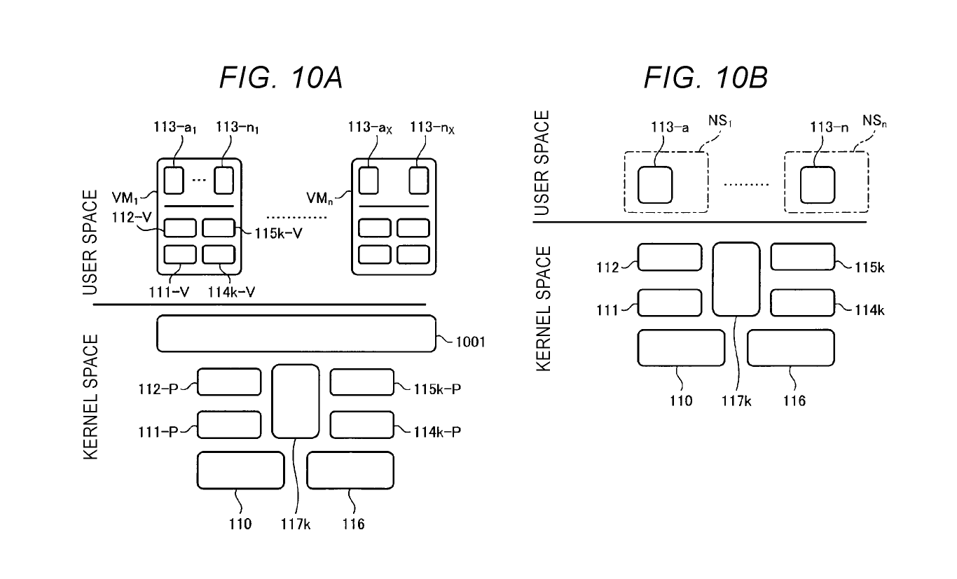

Further, the variation of the specific form of the communication application 113 may be, for example, the form illustrated in FIGS. 9A to 9C, 10A, and 10B. FIGS. 9A to 9C, 10A, and 10B are diagrams illustrating specific forms of the communication application 113 in the modification of the first embodiment and the second embodiment, respectively.

FIGS. 9A to 9C, 10A, and 10B are based on the block diagram of the second embodiment (see, e.g., FIG. 6), but is also applicable to the block diagram of the first embodiment (see, e.g., FIG. 1). Here, it is assumed that a general operating system (OS) operates on the processor 102.

FIG. 9A illustrates an example in which plural communication applications 113-1 to 113-n (n is an integer of 2 or more) are all provided in a user space, and other software (the device driver 110, the logical network interface driver 111, the communication protocol stack 112, the logical storage device driver 114k, the file system 115k, the physical storage device driver 116, and the access controller 117k) are provided in a kernel space.

FIG. 9B illustrates an example in which plural communication applications 113-1 to 113-n and other software 110 to 112, 114k, 115k, 116, and 117k are provided in the kernel space.

FIG. 9C is a combination of FIGS. 9A and 9B, and illustrates an example in which the communication application 113 of a portion of the plural communication applications 113-1 to 113-n is provided in the user space, and the other portion of the communication application 113 is provided in the kernel space.

In the example illustrated FIGS. 9A to 9C, the number of the communication applications 113 is not important, and multiple communication applications 113 may be executed within a range allowed by resources such as a memory.

FIG. 10A illustrates an example in which a virtualization function 1001 is mounted on the storage device 100k, and the communication application 113 is operated on virtual machines VM₁ to VMₙ by using the virtualization function 1001. Multiple communication applications 113 may be executed in the virtual machines VM₁ to VMₙ and virtual machines VM₁ to VMₙ may be executed.

For example, virtual machines VM₁ to VMₙ are provided in the user space, and a virtualization function 1001 is provided in the kernel space as well as the software similar to that of FIG. 9A (the device driver 110, a logical network interface driver 111-P, a communication protocol stack 112-P, a logical storage device driver 114k-P, a file system 115k-P, the physical storage device driver 116, and the access controller 117k). Each of the virtual machines VM₁ to VMₙ has a virtual user space and a virtual kernel space. Communication applications 113-a₁ to 113-n₁ are provided in the virtual user space of the virtual machine VM₁, and multiple pieces of software (e.g., a logical network interface driver 111-V, a communication protocol stack 112-V, a logical storage device driver 114k-V, and a file system 115k-V) are provided in the virtual kernel space of the virtual machine VM₁. The communication applications 113-aₓ to 113-nₓ are provided in the virtual user space of the virtual machine VMₙ and software 111-V, 112-V, 114k-V, and 115k-V are arranged in the virtual kernel space of the virtual machine VMₙ similarly to the virtual machine VM₁. The number of the communication applications 113 and the number of the virtual machines VM₁ to VMₙ are not important limitations.

High independence may be maintained among the virtual machines VM₁ to VMₙ, but the overhead associated with virtualization is large. To solve this problem, there is a container technique of separating management information such as a namespace. FIG. 10B illustrates an example in which the container technique is applied. In this figure, only one communication application 113-a to 113-n is in each of the namespaces NS₁ to NSₙ, but multiple communication applications may be included in each name space NS₁ to NSₙ (each container). Further, although not explicitly illustrated, the forms illustrated in FIGS. 9A to 9C, 10A, and 10B may be combined with each other in some examples.

In the forms illustrated in FIGS. 10A and 10B, each of the virtual machines VM₁ to VMₙ or each of the namespaces NS₁ to NSₙ (each container) is allocated with a unique logical storage unit that is logically reconfigured in the storage unit 104, and only the inside thereof is used. The partition described in the second embodiment may be used as a unique logical storage unit for the virtual machine and the container. Thus, it becomes possible to have multiple independent communication applications operate on the storage device 100k and to disclose the snapshot of the partition to the communication device 300 via another logical transmission path, such as the logical transmission path limited to the physical range. Furthermore, in some examples, the underlying partition may instead be disclosed to the communication device 300, and the snapshot may be disclosed to the communication application 113.

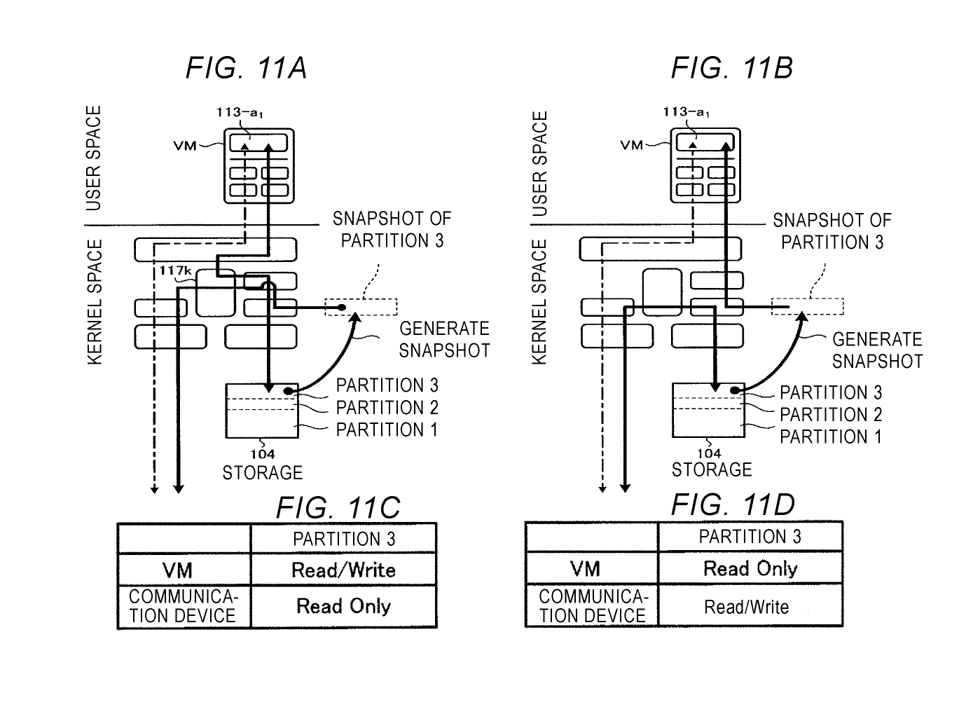

FIGS. 11A to 11D are diagrams illustrating examples of use cases of the communication application 113 in a modification of the first embodiment and the second embodiment. FIG. 11A illustrates a case in which the communication application 113 acquires and stores information from the management server 501 on the network (see, e.g., FIG. 5), and the communication device 300 (see, e.g., FIG. 5) reads the information from the snapshot and distributes the information to the terminal 502 in the network 500 to which the communication device 300 is connected. When the partition 3 among the partitions 1 to 3 is reconfigured in the storage unit 104 and used in the virtual machine VM and the communication device 300, the access controller 117k enables reading/writing for the partition 3 by the virtual machine VM and performs an access control with respect to the communication device 300 in a read only state, as illustrated in FIG. 11C.

FIG. 11B illustrates a case in which the communication device 300 (see, e.g., FIG. 5) collects local information and stores the information in the storage unit 104, and the communication application 113 reads information from the snapshot and appropriately performs a conversion processing to store the information in the management server 501 (see, e.g., FIG. 5). When the partition 3 (from among partition 1, partition 2, and partition 3) in the storage unit 104 is used in the virtual machine VM and the communication device 300, the access controller 117k sets a read only state for the virtual machine VM with respect to the partition 3 and control access to the communication device 300 in a readable/writable manner, as illustrated in FIG. 11D.

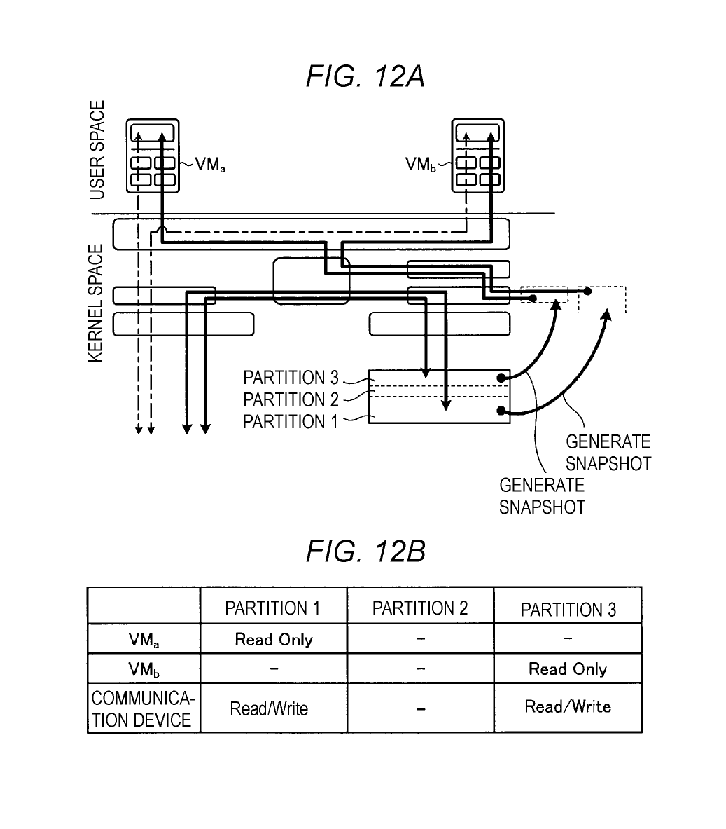

Further, the examples of FIGS. 11A and 11B illustrate the case where one virtual machine VM is used, but as illustrated in FIG. 12A, virtual machines Va and Vb may be used. FIG. 12A is a diagram illustrating another use case of the communication application in modifications of the first embodiment and the second embodiment. When the partition 1 in the storage unit 104 is used in the virtual machine Va and the communication device 300, the access controller 117k sets a read only state for the virtual machine VMa with respect to the partition 1 and control access to the communication device 300 in a readable/writable manner, as illustrated in FIG. 12B. When the partition 3 in the storage unit 104 is used in the virtual machine Vb and the communication device 300, the access controller 117k sets a read only state for the virtual machine VMb with respect to the partition 3 and control access to the communication device 300 in a readable/writable manner.

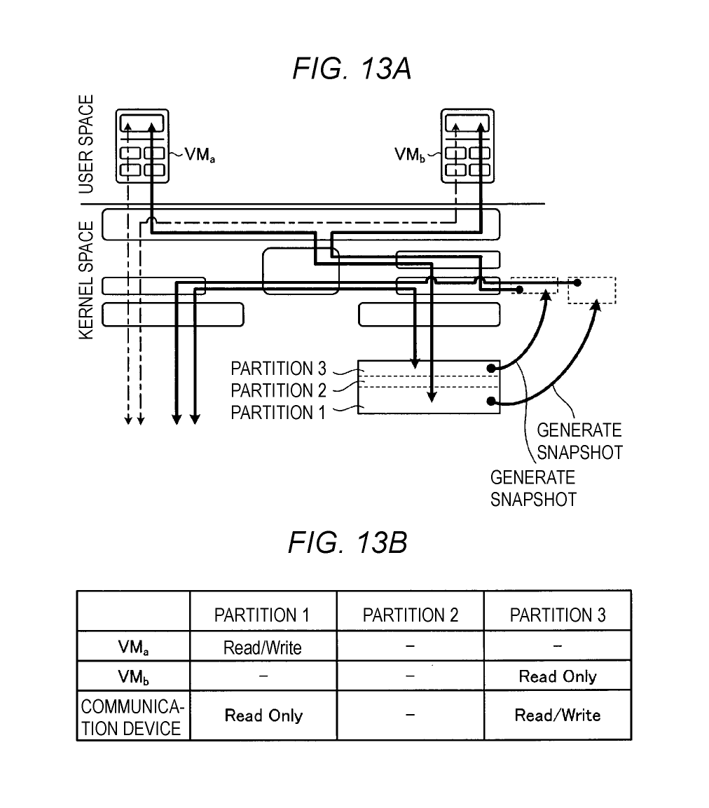

Alternatively, as illustrated in FIG. 13A, aspects of FIGS. 11A and 11B may be combined with each other. FIG. 13A is a diagram illustrating another use case of the communication application in modifications of the first embodiment and the second embodiment. That is, when the partition 1 in the storage unit 104 is used in the virtual machine Va and the communication device 300, the access controller 117k enables reading/writing for the virtual machine VMa with respect to the partition 1 and performs an access control with respect to the communication device 300 in a read only state, as illustrated in FIG. 13B. When the partition 3 is used in the virtual machine Vb and the communication device 300, the access controller 117k sets a read only state for the virtual machine VMb with respect to the partition 3 and control access to the communication device 300 in a readable/writable manner.

Alternatively, the present disclosure is applicable to a case where no virtual machine is used, a case where a container technique is used (see, e.g., FIG. 10B), and the like.

In addition, the timing for generating partitions or snapshots is either when communication devices requiring these partitions or snapshots are initially connected or when the communication application 113 is started up (initialized). The communication application 113 includes in some examples provision for the above-described virtual machine(s) or another implementation that uses a container technique. In any case, the necessary partitions or snapshots are generated by adding and updating the meta information described in the second embodiment before any access actually occurs. As described in the second embodiment, when the existing partitions may achieve the intended access restrictions, no new partitions are generated, and the processing is performed using the existing partitions.

Alternatively, multiple second logical communication paths, which are not limited to the physical connection range, may be constructed in the storage device 100k. Methods of constructing the second logical communication path are roughly classified into two general methods. One method is to increase the number of second logical communication paths, and the other is to add an additional identifier on the logical communication path to multiplex within the same logical communication path. As an example of the former, there is a method of increasing functions or the number of interfaces in a multi-function device of a PCI Express or a USB. As an example of the latter, when the second logical communication path uses a communication protocol based on IEEE 802.3, one second logical communication path may be treated or operated as multiple logical communication paths by inserting a VLAN tag based on IEEE 802.1Q or the like.

In the first embodiment and the second embodiment, when the partition is configured from a large-capacity storage unit, changing the internal information is not assumed to be performed. However, when the file system includes the owner information and the like, the information in the external device and the information in the storage device 100k may be different from each other. Therefore, a unit of dynamically mapping the information in the processor 102 may be added in the storage device 100k. The mapping function is noted as a portion of the meta information via the second logical communication path. Upon receiving the meta information including mapping information, the storage device 100k performs a determination of whether the partition is referenceable, performs a conversion processing based on the received mapping information, and then makes it possible to refer to the information from a predetermined access subject. The conversion processing may be performed collectively once or may be sequentially performed every time information is accessed.

In the first embodiment and the second embodiment, it is assumed that the application operating on the storage device 100k and the external device connected to the storage device 100k (e.g., the communication device 300) is installed in advance. However, an appropriate application is not always pre-installed on the external device. Thus, the application previously stored in the storage device 100k side may be installed and executed in the external device to which the storage device 100k is connected. In this case, the storage unit 104 maintains a program suitable for the external device that is to be connected via the interface 101. Such a program may need to be modified according to the CPU architecture, operating system library files, etc. of the external device. In order to alleviate this restriction, a program using an interpreter language or a program using an intermediate language may be used. Further, in order to solve inconsistency of library files, the program may be stored as a container that integrates execution environments such as the executable file and the necessary library files.

When the storage device 100k and the external device recognize that the two devices are connected to each other in a certain way, the application stored in the storage device 104 is installed on the external device side. The installation may be executed from the external device, or the storage device 100k side may issue a trigger to execute the installation in the external device.

The storage device 100k receives a notification of the meta information from the external device while the installation is being executed or after the installation is completed. As described above, the storage device 100k determines whether a new partition is required based on the received meta information, and generates and allocates a partition as needed. Other operations are the same as the respective operations described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a storage unit;
an interface that is physically connectable to a network; and
a controller configured to establish a first logical communication path via the interface in a first communication software layer, through which data is read from and stored in the storage unit, and a second logical communication path via the interface in a second communication software layer higher than the first communication software layer, through which meta information for controlling access to the storage unit is communicated.

2. The storage device according to claim 1, wherein the controller includes an access controller configured to:
reconfigure the storage unit as one or more logical storage units to which a read or write operation is to be performed through the first logical communication path,
acquire meta information for controlling access to the logical storage units through the second logical communication path, and
perform an access control to the logical storage units based on the acquired meta information.

3. The storage device according to claim 2, wherein the access controller is further configured to:
reconfigure the storage unit according to the acquired meta information to include at least a new logical storage unit to which a read or write operation is to be performed through the first logical communication path.

4. The storage device according to claim 3, wherein the access controller reconfigures the storage unit to include the new logical storage unit after a requested access to one of the existing logical storage units is rejected.

5. The storage device according to claim 4, wherein the meta information for the new logical storage unit includes a maximum number of read times, start and end times for when the new logical storage unit is readable, start and end times for when the new logical storage unit is writable, access requestor process information, and access requestor user information as access control information for the new logical storage unit.

6. The storage device according to claim 1, wherein the storage unit includes a first partition and a second partition, and access to the first partition through the first logical communication path is permitted or rejected based on first meta information communicated through the second logical communication path, and access to the second partition through the first logical communication path is permitted or rejected based on second meta information communicated through the second logical communication path.

7. The storage device according to claim 6, wherein the controller implements a first file system for the first partition and a second file system different from the first file system for the second partition.

8. The storage device according to claim 6, wherein the controller generates a new partition when the controller determines that access to any of existing partitions is not permitted.

9. A storage device comprising:
a processor that executes instructions in a user space and a kernel space;
a storage unit;
an interface; and
a plurality of virtual machines executing on the processor to share the interface and the storage unit, wherein each of the virtual machines has software modules executing in the kernel space that establish a first logical communication path via the interface in a first communication software layer, through which data is read from and stored in the storage unit, and a second logical communication path via the interface in a second communication software layer higher than the first communication software layer, through which meta information for controlling access to the storage unit is communicated.

10. The storage device according to claim 9, wherein the virtual machines include a first virtual machine and a second virtual machine, and data of the first virtual machine is read from and written to the storage unit via the first logical communication path established by software modules of the first virtual machine and data of the second virtual machine is read from and written to the storage unit via the first logical communication path established by software modules of the second virtual machine.

11. The storage device according to claim 10, wherein the first virtual machine reads from and writes to a first partition of the storage unit and the second virtual machine reads from and writes to a second partition of the storage unit.

12. The storage device according to claim 11, wherein the software modules of the first virtual machine reconfigure the storage unit to create another partition after a requested access to one of existing partitions is rejected.

13. The storage device according to claim 11, wherein the first virtual machine implements a first file system for the first partition and the second virtual machine implements a second file system different from the first file system for the second partition.

14. A control method of a storage device that includes a storage unit and an interface that is physically connectable to a network, said control method comprising:
establishing a first logical communication path via the interface in a first communication software layer, through which data is read from and stored in the storage unit; and
establishing a second logical communication path via the interface in a second communication software layer higher than the first communication layer, through which meta information for controlling access to the storage unit is communicated.

15. The control method according to claim 14, further comprising:
reconfiguring the storage unit as one or more logical storage units to which a read or write operation is to be performed through the first logical communication path;
acquiring meta information for controlling access to the logical storage units through the second logical communication path; and
performing an access control to the logical storage units based on the acquired meta information.

16. The control method according to claim 15, further comprising:
reconfiguring the storage unit according to the acquired meta information to include at least a new logical storage unit to which a read or write operation is to be performed through the first logical communication path.

17. The control method according to claim 16, wherein the storage unit is reconfigured to include the new logical storage unit after a requested access to one of the existing logical storage units is rejected.

18. The control method according to claim 17, wherein the meta information for the new logical storage unit includes a maximum number of read times, start and end times for when the new logical storage unit is readable, start and end times for when the new logical storage unit is writable, access requestor process information, and access requestor user information as access control information for the new logical storage unit.

19. The control method according to claim 14, wherein the storage unit includes a first partition and a second partition, and access to the first partition through the first logical communication path is permitted or rejected based on first meta information communicated through the second logical communication path, and access to the second partition through the first logical communication path is permitted or rejected based on second meta information communicated through the second logical communication path.

20. The control method according to claim 19, wherein a first file system is implemented for the first partition and a second file system different from the first file system is implemented for the second partition.
